(19) United States
(12) Patent Application Publication
(10) Pub. No.: US 2002/0166856 A1
(43) Pub. Date: Nov. 14, 2002

(54) Junction box case with bus bars housed therein

(75) Inventor: Kazuhiko Yoshie, Hokkaido (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 10/141,931

(22) Filed: May 10, 2002

(30) Foreign Application Priority Data
May 11, 2001 (JP) P-2001-141563

(51) Int. Cl. H02G 3/08

(52) U.S. Cl. 220/3.2

(57) ABSTRACT

A junction box case which includes a first board member; a second board member stacked on the first board member; and a bus bar to be housed in a housing space defined by the first and second board members. The bus bar has a widened portion where a width thereof is larger than a width restricted by the housing space. The widened portion of the bus bar is folded back and overlapped, so as to be fitted within the width restricted by the housing space, whereby the widened portion is housed in the housing space.

### BACKGROUND OF THE INVENTION

1. Field of the Invention

The present invention relates to a junction box case with bus bars housed therein.

2. Description of the Related Art

Regarding bus bars housed inside a junction box case of a junction box installed on an engine room or the like of an automobile, reduction in wiring areas and in the number of stacked layers have been desired for downsizing the junction box.

Such a junction box case conceivably includes a wiring plate and wiring boards disposing a plurality of bus bars thereon. The bus bars are housed in shallow bus bar housing spaces formed on contact faces of the wiring boards to be stacked on a flat contact face of the wiring plate, in such a manner that the bus bars do not contact one another.

When the bus bars constitute a power circuit, a large electric current may flow thereon. Accordingly, there is a demand for enlarging a cross section for electric current conduction as much as possible in order to suppress a temperature rise.

However, due to dimensional restrictions of the junction box, areas for the bus bar housing spaces inside the case are restricted to specified sizes. Therefore, it is difficult to simply increase widths of the bus bars.

Though it is conceivable to increase the cross section for electric current conduction by partially increasing board thicknesses of the bus bars, such a mode is actually unpractical because adoption of bus bars of different board thicknesses would affect uniformity in components and a fabricating process thereof.

### SUMMARY OF THE INVENTION

The object of the present invention is to provide a junction box case capable of housing a bus bar within a space of a restricted width, meanwhile, suppressing a temperature rise of the bus bar.

A first aspect of the present invention is a junction box case comprising: a first board member and a second board member, the second board member stacked on the first board member; and a bus bar housed in a housing space defined by the first and second board members, the bus bar including a widened portion where a width thereof is larger than a width restricted by the housing space, wherein the widened portion of the bus bar is folded back and overlapped so as to be fitted within the width restricted by the housing space, whereby the widened portion is housed in the housing space.

According to the first aspect of the present invention constituted as described above, the bus bar can be widened and a cross section for electric current conduction thereof can be increased. Due to the increased cross section of the bus bar, an amount of heat generation attributable to electric conduction is suppressed. And due to an increased surface area of the bus bar, an amount of heat release is increased. Moreover, the widened portion is folded back and overlapped in order to house the bus bar in the housing space of the restricted width. Accordingly, it is possible to surely prevent a temperature rise of the bus bar without increasing its width dimensions, thus contributing to downsizing of a junction box with very little modification in configurations of other components.

A second aspect of the present invention is the junction box case according to the first aspect, in which the widened portion of the bus bar, which is folded back, is overlapped with provision of a clearance.

According to the second aspect of the present invention constituted as described above, a clearance is secured at the overlapping portion of the bus bar. In this way, it is possible to surely increase a heat releasing area, whereby a temperature rise of the bus bar can be suppressed.

A third aspect of the present invention is the junction box case according to the first aspect, in which the housing space is divided into a main bus bar housing space for housing principal parts of the bus bar and a sub bus bar housing space for housing a portion of the widened portion, which is thickened by being folded back and overlapped, and wherein any one of the first and second board members includes the main bus bar housing space and the other board member includes the sub bus bar housing space.

Preferably, the first and second board members include guiding means for guiding the both board members for positioning when the both board members are stacked.

According to the third aspect of the present invention constituted as described above, the bus bar can be housed inside main and sub bus bar housing spaces formed on contact faces of two board members. Particularly, principal parts of the bus bar can be housed inside the main bus bar housing space formed on one of the board members; meanwhile, a portion of the bus bar, which is virtually thickened by being folded back and thereby protrudes out of the foregoing board member, can be housed inside the sub bus bar housing space formed on the other board member. Accordingly, it is not necessary to modify the board member for housing the principal parts of the bus bar, such as increasing the thickness thereof. Meanwhile, guiding means provided on the both board members prevent the portion of the bus bar protruding out of the one of the boarding members due to the increase in thickness, from interfering with the opponent board member upon stacking the board members, thus effectuating smooth and secure assembly of the both board members and protection of the protruding portion as well.

A fourth aspect of the present invention is a junction box case comprising: a first board member and a second board member, the second board member stacked on the first board member; and a bus bar housed in a housing space defined by the first and second board members, the bus bar including a widened portion where a width thereof is larger than a width restricted by the housing space, wherein the widened portion of the bus bar is curved into corrugation so as to be fitted within the width restricted by the housing space, whereby the widened portion is housed in the housing space.

According to the fourth aspect of the present invention constituted as described above, the bus bar can be widened and a cross section for electric current conduction thereof can be increased. Due to the increased cross section of the bus bar, an amount of heat generation attributable to electric conduction is suppressed. And due to an increased surface area of the bus bar, an amount of heat release is increased. Furthermore, the widened portion is curved into corrugation and housed inside the housing space of the restricted width. Accordingly, it is possible to secure a clearance for heat release inside the housing space. As a result, a temperature rise of the bus bar can be surely prevented without increase in dimensions, thus contributing to downsizing of the junction box with very little modification in configurations of other components.

A fifth aspect of the present invention is the junction box case according to the fourth aspect, in which the housing space is divided into a main bus bar housing space for housing principal parts of the bus bar and a sub bus bar housing space for housing a portion of the widened portion, which is thickened by being corrugated, and wherein any one of the first and second board members includes the main bus bar housing space and the other board member includes the sub bus bar housing space.

Preferably, the first and second board members include guiding means for guiding the both board members for positioning when the both board members are stacked.

According to the fifth aspect of the present invention constituted as described above, the bus bar can be housed inside main and sub bus bar housing spaces formed on contact faces of two board members. Particularly, principal parts of the bus bar can be housed inside the main bus bar housing space formed on one of the board members; meanwhile, a portion of the bus bar, which is virtually thickened by being curved into corrugation and thereby protrudes out of the foregoing board member, can be housed inside the sub bus bar housing space formed on the other board member. Accordingly, it is not necessary to modify the board member f or housing the principal parts of the bus bar, such as increasing the thickness thereof. Meanwhile, guiding means provided on the both board members prevent the portion of the bus bar protruding out of the one of the boarding members due to the increase in thickness, from interfering with the opponent board member upon stacking the board members, thus effectuating smooth and secure assembly of the both board members and protection of the protruding portion as well.

### BRIEF DESCRIPTION OF THE DRAWINGS

The invention will now be described with reference to the accompanying drawings wherein:

FIG. 1A is a sectional side elevation showing principal parts of a junction box case, a wiring plate and a wiring board according to a first embodiment of the present invention, which illustrates a cross section taken along IA-IA line in FIG. 1B;

FIG. 1B is a plan view of the principal parts of the junction box case of the first embodiment, which is taken along IB-IB line in FIG. 1A and illustrates a contact face of the wiring plate and bus bars disposed between the wiring board and the wiring plate;

FIG. 1C is a plan view of the principal parts of the junction box case of the first embodiment, which is taken along IC-IC line in FIG. 1A and illustrates a contact face of the wiring board and the bus bars disposed between the wiring board and the wiring plate;

FIG. 2A is a sectional side elevation showing principal parts of a junction box case, a wiring plate and a wiring board according to a second embodiment of the present invention, which illustrates a cross section taken along IIA-IIA line in FIG. 2B;

FIG. 2B is a plan view of the principal parts of the junction box case of the second embodiment, which is taken along IIB-IIB line in FIG. 2A and illustrates a contact face of the wiring plate and bus bars disposed between the wiring board and the wiring plate; and

FIG. 2C is a plan view of the principal parts of the junction box case of the second embodiment, which is taken along IIC-IIC line in FIG. 2A and illustrates a contact face of the wiring board and the bus bars disposed between the wiring board and the wiring plate.

### DETAILED DESCRIPTION OF THE PREFERRED EMBODIMENTS

Embodiments of the present invention will be explained below with reference to the drawings, wherein like members are designated by like reference characters.

### First Embodiment

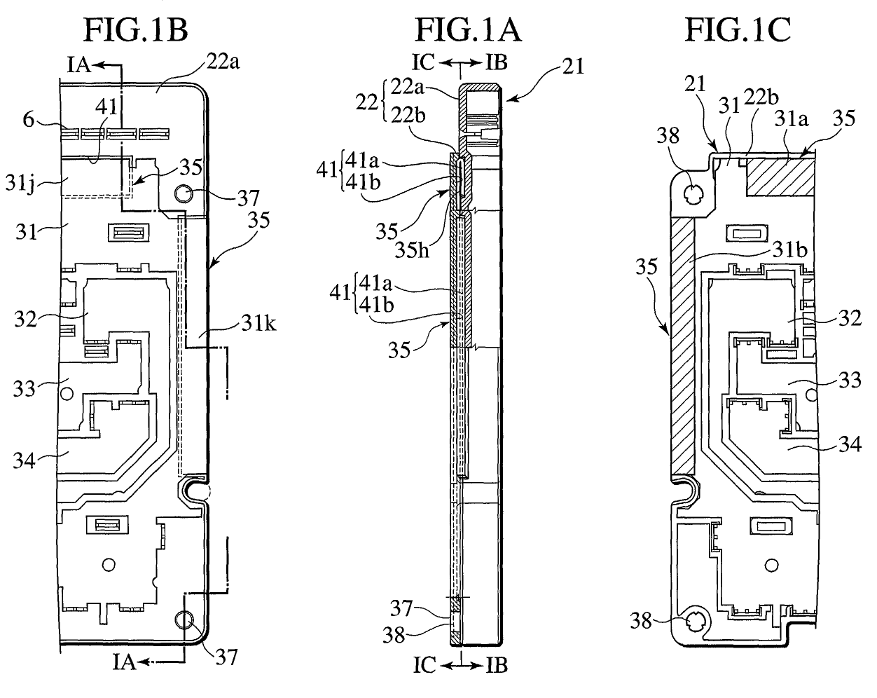

As shown in FIG. 1A, a case 22 for a junction box 21 includes a wiring plate 22a (as a first board member) and a wiring board 22b (as a second board member). Bus bars are disposed on top and bottom faces of the wiring board 22b. The wiring board 22b is stacked on a contact face of the wiring plate 22a and thereby integrated in a state where the bus bars are loaded on the top and the bottom faces thereof.

As shown in FIG. 1B and FIG. 1C, the bus bars are disposed between the wiring plate 22b and the wiring plate 22a. Here, first to fourth bus bars 31, 32, 33 and 34 are disposed on one plane, and the respective bus bars are held between the wiring board 22b and the wiring plate 22a in a state not to contact with one another.

The bus bar 31 constituting a power circuit includes an enlarged cross section for electric current conduction, which is formed by increasing a circuit width (a width when being stretched) of the bus bar 31 greater than a width restricted by a housing space 41 at a first position 31j and a second position 31k where dimensions in the width direction are strictly restricted. Moreover, portions 31a and 31b formed larger than the restricted width (illustrated as shaded areas in FIG. 1C) are folded back toward the wiring plate and overlapped, whereby dimensions of the bus bar 31 are formed as installable within the restricted width. In this case, as shown in FIG. 1A, a clearance 35h for improving heat-releasing performance of the bus bar 31 is secured at each overlapping portion 35 of the bus bar 31, and the bus bar 31 is housed in the housing space 41 in the above-described state.

As to the housing space 41, a main bus bar housing space 41b is formed on a contact face of the wiring board 22b for housing the principal parts of the bus bar 31, and a sub bus bar housing space 41a is formed on the contact face of the wiring plate 22a for housing a portion which is virtually thickened because the bus bar 31 is folded back and overlapped.

Moreover, an engaging boss 37 and a boss engaging hole 38 (collectively constituting guiding means) for guiding positions of the wiring plate 22a and the wiring board 22b are severally provided thereon, in order to prevent a portion protruding outward from the wiring board 22b due to a partial increase in the thickness of the bus bar 31, from interfering with the wiring plate 22a upon stacking the wiring board 22b and the wiring plate 22a.

When the case 22 for the junction box 21 is assembled, the bus bars 31 to 34 are loaded on the wiring board 22b in advance, and then the wiring board 22b is stacked on the contact face of the wiring plate 22a. Accordingly, the bus bars 31 to 34 are held between the wiring board 22b and the wiring plate 22a. In this event, the portions of the bus bar 31 thickened by being folded back (the portions of the overlapping portions 35 where the bus bar 31 protrudes outward from the contact face of the wiring board) are fitted into the sub bus bar housing space 41a on the wiring plate 22a. Here, upon stacking the wiring board 22b on the contact face of the wiring plate 22a, the engaging boss 37 and the boss engaging hole 38 are engaged with each other, thus guiding the positions of the wiring board 22b and the wiring plate 22a. Accordingly, the portions of the bus bar 31 protruding from the wiring board 22b are protectively and surely fitted into the sub bus bar housing space 41a on the wiring plate 22a.

According to the case 22 for the junction box 21 of the above-described constitution, a cross section for electric conduction is enlarged by widening the bus bar 31 partially. Therefore, it is possible to suppress heat generation attributable to electric conduction and to increase an amount of heat release by an increase in a surface area due to the widening of the bus bar. Moreover, the widened portion is folded back and overlapped, and then housed inside the housing space 41 of the restricted width. In this way, a temperature rise of the bus bar 31 can be surely prevented while avoiding an increase in width dimensions. Accordingly, high densification and downsizing of the junction box 21 can be achieved with very little requirements for modifying other configurations of the bus bars 32 to 34, the wiring board 22b and the wiring plate 22a.

### Second Embodiment

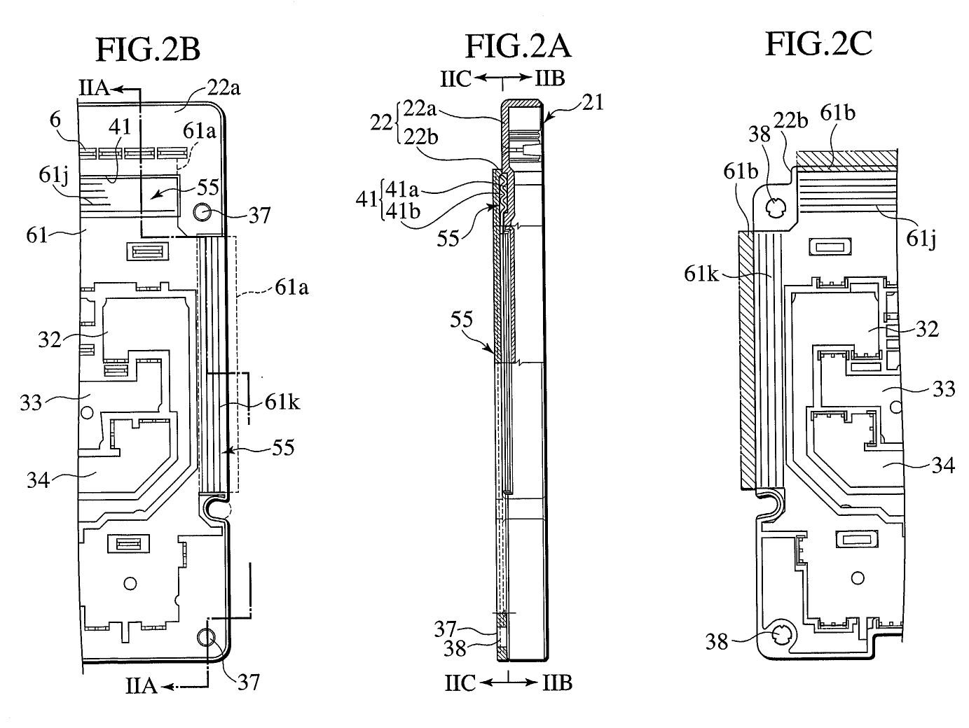

A difference between a second embodiment and the first embodiment is that a portion of a bus bar 61 for a power circuit, which is formed larger than a width restricted by a housing space 41, is not folded back and overlapped. Instead, the portion is curved into corrugation (such a corrugated portion is denoted by reference numeral 55) as shown in FIG. 2A and fitted into the housing space 41. All other portions of the second embodiment are identical to those of the first embodiment. Accordingly, the identical portions are denoted by the same reference numerals and description thereto will be omitted herein.

Regarding a case 22 for a junction box 21 according to the embodiment, at a first portion 61j and a second portion 61k of the bus bar 61 where width dimensions are strictly restricted, widths of the bus bar 61 are virtually enlarged as equivalent to dimensions 61a and 61b as illustrated with a dotted line and shaded areas in FIG. 2B and FIG. 2C. Such widened portions of a plate are formed into corrugations and fitted into defined widths, whereby the bus bar 61 is fitted in the housing space 41 of the restricted width. Moreover, portions virtually thickened by curving the bus bar 61 into corrugations are housed in a sub bus bar housing space 41a formed on a wiring plate 22a.

According to the case 22 for the junction box 21 of the above-described constitution, a cross section for electric conduction is enlarged by widening the bus bar 61 partially. Therefore, it is possible to suppress heat generation attributable to electric conduction and to increase an amount of heat release by an increase in a surface area due to the widening of the bus bar. Moreover, the widened portion is curved into corrugation, and then housed inside the housing space 41 of the restricted width. In this way, it is possible to secure a clearance for heat release inside the housing space 41. As a result, a temperature rise of the bus bar 61 can be surely prevented while avoiding an increase in the dimensions. Accordingly, high densification and downsizing of the junction box 21 can be achieved with very little requirements for modifying other configurations of the bus bars 32 to 34, the wiring board 22b and the wiring plate 22a.

Although only two embodiments of the invention have been disclosed and described, it is apparent that the other embodiments and modification of the invention are possible.

What is claimed is:

1. A junction box case comprising:
a first board member and a second board member, the second board member stacked on the first board member; and
a bus bar housed in a housing space defined by the first and second board members, the bus bar including a widened portion where a width thereof is larger than a width restricted by the housing space,
wherein the widened portion of the bus bar is folded back and overlapped so as to be fitted within the width restricted by the housing space, whereby the widened portion is housed in the housing space.

2. The junction box case according to claim 1, wherein the widened portion of the bus bar, which is folded back, is overlapped with provision of a clearance.

3. The junction box case according to claim 1,
wherein the housing space is divided into a main bus bar housing space for housing principal parts of the bus bar and a sub bus bar housing space for housing a portion of the widened portion, which is thickened by being folded back and overlapped, and
wherein any one of the first and second board members includes the main bus bar housing space and the other board member includes the sub bus bar housing space.

4. The junction box case according to claim 3,where in the first and second board members include guiding means for guiding the both board members for positioning when the both board members are stacked.

5. A junction box case comprising:
a first board member and a second board member, the second board member stacked on the first board member; and
a bus bar housed in a housing space defined by the first and second board members, the bus bar including a widened portion where a width thereof is larger than a width restricted by the housing space,
wherein the widened portion of the bus bar is curved into corrugation so as to be fitted within the width restricted by the housing space, whereby the widened portion is housed in the housing space.

6. The junction box case according to claim 5,
wherein the housing space is divided into a main bus bar housing space for housing principal parts of the bus bar and a sub bus bar housing space for housing a portion of the widened portion, which is thickened by being corrugated, and
wherein any one of the first and second board members includes the main bus bar housing space and the other board member includes the sub bus bar housing space.

7. The junction box case according to claim 6, wherein the first and second board members include guiding means for guiding the both board members for positioning when the both board members are stacked.
